(19) United States
(12) Patent Application Publication
(10) Pub. No.: US 2007/0193653 A1
(43) Pub. Date: Aug. 23, 2007

(54) BEVERAGE DISPENSER

(76) Inventors: Thomas Gagliano, Marciana Marina (LI) (IT); Iver J. Phallen, Youngstown, NY (US); Douglas Vogt, Grand Island, NY (US)

Correspondence Address: FISH & RICHARDSON P.C., P.O. BOX 1022, MINNEAPOLIS, MN, 55440-1022, US

(21) Appl. No.: 11/611,713

(22) Filed: Dec. 15, 2006

Related U.S. Application Data
(60) Provisional application No. 60/751,167, filed on Dec. 15, 2005.
(60) Provisional application No. 60/795,823, filed on Apr. 28, 2006.

(51) Int. Cl. B67C 3/26

(52) U.S. Cl. 141/256

(57) ABSTRACT

A beverage dispenser for carbonated beverages, such as draft beer and soda, includes a volumetric beverage flow rate controller in the form of a tubular restrictor or choker combined with a subsurface flow beverage dispensing nozzle assembly. The nozzle has a positive bottom shut-off moveable between open and closed positions for initiating and stopping flow into the container. At defined rates of serving speed, greater control over pour characteristics, particularly over foam formed on the top of the beverage, is achieved.

### CROSS-REFERENCE TO RELATED APPLICATIONS

This application claims the benefit of U.S. Provisional Patent Application No. 60/751,167, filed Dec. 15, 2005 and entitled “Beverage Dispenser,” and U.S. Provisional Patent Application No. 60/795,823, filed Apr. 28, 2006 and entitled “Method and apparatus for controlling the quantity of foam of dispensed beverages,” the disclosures of which are hereby incorporated by reference in their entirety.

### TECHNICAL FIELD

The present disclosure relates to apparatus, systems, and methods for dispensing beverages, and more particularly, to a beverage dispenser for carbonated beverages, such as draft beer and soda.

### BACKGROUND

One goal of carbonated beverage dispensers, particularly for draft beer, is to control the amount of foam on top of the liquid beverage at the conclusion of a pour. One approach to meeting this goal is to restrict or limit the volumetric flow rate (unit volume in unit time) of beverage entering the serving vessel in order to reduce flow trauma foaming.

### SUMMARY

In one general aspect, a carbonated beverage dispenser includes a discrete volumetric liquid flow rate control or controller and a subsurface filling bottom shut-off beverage dispensing nozzle. The dispenser may combine a flow limiter and a subsurface dispensing beverage nozzle in which the flow limiter defines volumetric flow rate from the bottom shut-off beverage nozzle and is a flow tube of reduced diameter relative to the beverage flow line connecting the beverage source to the flow limiter. This reduced diameter beverage flow tube can be termed a flow limiter, a flow restrictor, a flow reducer, a flow choker, a choker, or a beverage line restriction.

In another aspect, a carbonated beverage dispenser may combine a reduced diameter tubular volumetric flow rate reducer and a subsurface dispensing beverage nozzle in which multiple flow tubes (also referred to as choker tubes) are arranged in parallel to one another with a common liquid source and a common liquid discharge, with each tube having an associated flow control valve that allows or blocks flow dependent upon whether the valve is opened or closed. The flow tubes can be of the same length and diameter, of the same diameter but different lengths, of different diameters but the same length, or of different diameters and different lengths, so as to allow relatively large and complex dispenser volumetric flow rate selections based upon selecting a flow or flows using the flow control valve on each branch. The use of multiple valved parallel tubes, regardless of their length and diameter, may allow the volumetric flow rate of beverage into a serving vessel to be varied or altered from one beverage to the next, and in response to changes in beverage pour conditions or parameters such as beverage pressure or beverage temperature.

In a further aspect, a carbonated beverage dispenser combines a reduced diameter tubular volumetric flow rate reducer and a subsurface dispensing beverage nozzle in which a reduced diameter tubular volumetric flow rate restrictor is located as a coiled structure, primarily within the nozzle barrel lumen of the bottom shut-off subsurface filling beverage dispensing nozzle.

In another aspect, a carbonated beverage dispenser combines a reduced diameter tubular volumetric flow rate reducer and a subsurface dispensing beverage nozzle in which a choker tube has flow control valved series shunts that serve to increase or decrease flow resistance as measured between the choker inflow point and the choker outflow point. Such an arrangement may allow the volumetric flow rate of beverage into a serving vessel to be varied or altered from one beverage pour to the next or during a discrete beverage pour, and in response to changes in beverage pour conditions or parameters such as beverage pressure or beverage temperature.

Other features will be apparent from the following description, including the drawings, and the claims.

### BRIEF DESCRIPTION OF THE DRAWINGS

FIG. 1 is a view of a dispensing system.

FIG. 2 is a view of another dispensing system that includes a manual control handle.

FIGS. 3-6 are views of beverage dispensers in which the volumetric liquid flow rate controller is physically separated from the subsurface positive shut-off nozzle assembly.

FIGS. 7 and 8 are views of beverage dispensers in which the volumetric liquid flow rate controller is located in a beer tower which is mounted on a vertical mount surface. FIGS. 9-10 are views of beverage dispensers in which the volumetric liquid flow rate controller is located in a beer tower which is mounted on a horizontal mount surface.

FIG. 11 is a view of a beverage dispenser in which a volumetric liquid flow rate controller is located in a beer tower and a further volumetric liquid flow rate controller is located in a water bath cooler physically separated from the subsurface positive shut-off nozzle assembly.

FIG. 12 is a view of a beverage dispenser in which a serpentine flow rate controller is located in a beer tower which can be clamped on a horizontal surface.

FIGS. 13 and 14 are views of serpentine and coiled volumetric flowrate restrictors located in the nozzle barrel lumen of the bottom shut-off subsurface filling beverage dispensing nozzle, with FIG. 13 showing a manual control handle and FIG. 14 showing an automatic control.

FIGS. 15 and 16 are views of a beer tower including a cooling apparatus.

FIG. 17 is a view of a beverage dispenser showing parallel valved restrictor tubes.

FIG. 18 is a view of a beverage dispenser showing a flow restrictor with valved series shunts.

FIG. 19 is a schematic view of a beverage dispenser showing a flow restrictor with valved series/parallel shunts.

FIGS. 20 and 21 are enlarged front and side views of the electronic controller shown in FIG. 11.

FIG. 22 is an illustration of a bottom plate for a beer tower provided with cooling equipment.

FIG. 23 shows a beverage dispensing nozzle assembly with the beverage dispensing shut-off valve in the closed position, and further showing a pneumatic control valve for causing the shut-off valve to be moved between the open and closed position.

FIG. 24 is a view similar to FIG. 23, but showing the beverage dispensing shut-off valve in the open position.

FIG. 25 is an enlarged detail view of a portion of FIGS. 23 and 24 showing the beverage temperature sensor and the beverage pressure sensor.

FIGS. 26-28 are schematic illustrations of various nozzle plug or shut-off valve positions.

FIGS. 29 to 32 are digital graphs showing flow action as a function of nozzle motion.

FIGS. 33-35 are flow charts.

### DETAILED DESCRIPTION

Generally speaking, the beverage dispenser described herein includes a subsurface filling positive shut-off dispensing nozzle combined in various ways with a volumetric liquid flow rate control device or devices to provide relatively rapid dispensing of carbonated beverages, such as draft beer and soda, with user defined pour attributes and a high degree of control and repeatability of operation from pour to pour over extended time periods.

The volumetric liquid flow rate controller is illustratively a tubular long flow axis flow reducer having a generally smooth, uninterrupted interior, and being generally comprised of a specified length of tubing of a particular internal diameter, the internal diameter being smaller than the internal diameter of the beverage flow line from the beverage supply source. Such a flow rate controller can be referred to as a tubular restrictor or “choker”. In operation, such a tubular restrictor gradually reduces beverage flow rate by presenting an analog pressure dropping or reducing differential along its flow axis. Thus, the longer the length, or the smaller the diameter, of the tubular restrictor, the greater the flow reduction. Because the pressure drop of the beverage is relatively gradual, these chokers can be relatively effective as flow control elements in draft beer systems.

A volumetric liquid flow rate is conventionally expressed and defined as units of volume per units of time as measured at a defined point or location in a liquid flow conduit or flow containment. For example, ten gallons per minute or one ounce per second are expressions of volumetric flow rate. Liquid flow velocity is a distinct and separate concept from volumetric liquid flow rate. Liquid flow velocity is conventionally expressed and defined as instantaneous volume of flow per unit of square area as measured at a defined point or location in a liquid flow conduit or containment. For example, one gallon per second per square inch or 400 liters per second per square meter are expressions of liquid flow velocity.

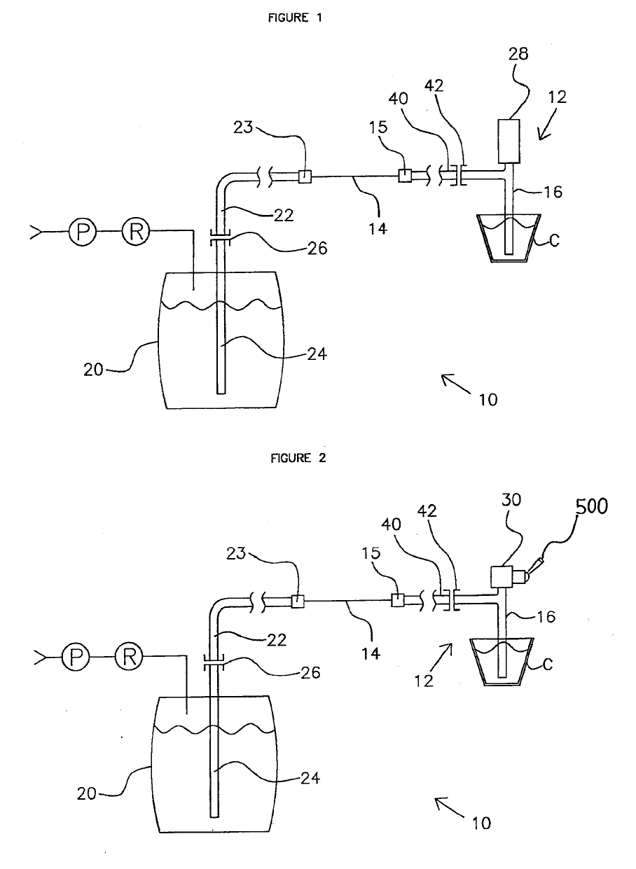

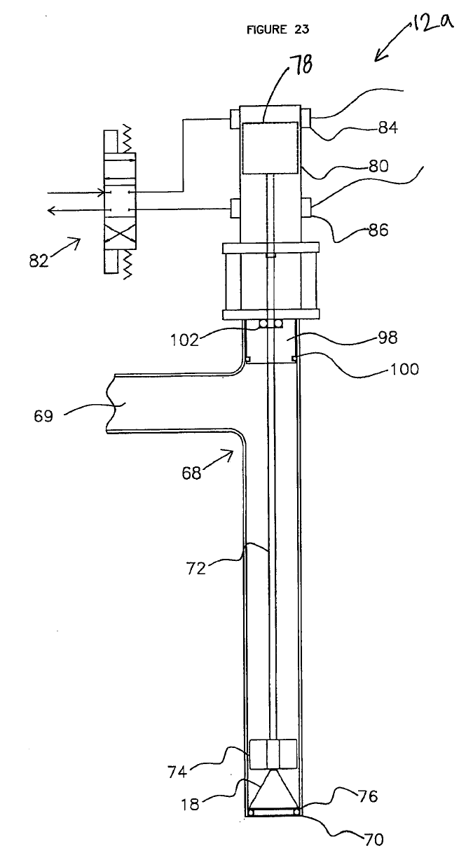

FIGS. 1 and 2 illustrate a beverage dispensing system 10. In the following detailed description, the system 10 will be described as a beer dispenser, but it should be appreciated that the system 10 may be used with other carbonated or non-carbonated beverages. The beverage dispenser includes a beverage dispensing nozzle assembly 12 and a volumetric liquid flow rate controller 14 that includes one or more reduced diameter beverage flow tubes. These tubes are illustratively shown as having constant diameter and may be formed of, for example, stainless steel or of a flexible non-metallic tubing of a material suitable for beverage contact, and for containing beverage flow. The nozzle assembly 12 includes a dispensing tube or nozzle barrel 16 which, as shown in FIG. 23, may be closed by a shut-off valve or nozzle plug 18. The beverage dispenser is shown connected to a beverage supply 20, such as a beer keg , by a conduit or beverage flow line 22 which originates from a dip tube 24 and a keg connector 26 of the beer keg 20. The beverage supply is kept at a rack pressure via a pressure source P which delivers gas to the keg, the pressure being regulated by a pressure regulator R. When the beverage dispenser 10 has been primed within the nozzle barrel 16, the beer is at rack pressure as long as a shut-off valve 18 is closed.

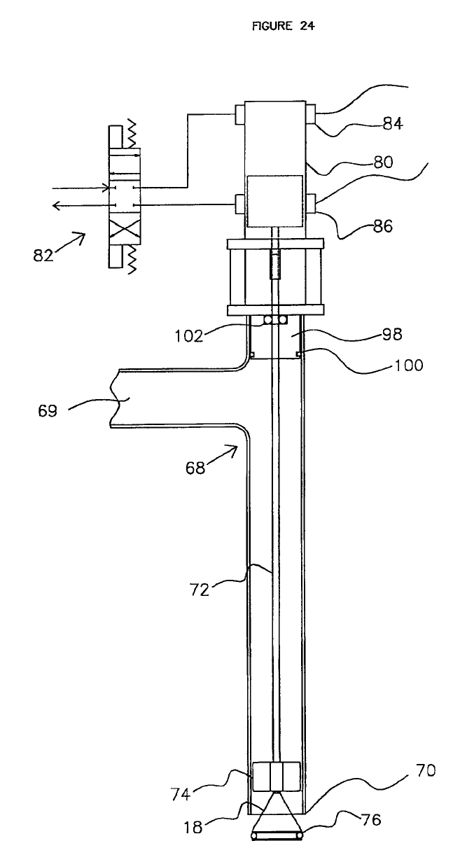

To dispense beer, a beverage container C, which may be, for example, a beer pitcher, a beer cup, or beer glass, is positioned as shown with the bottom of the nozzle assembly 16 positioned inside the beverage container. The shut-off valve 18 is then moved from its closed position (FIG. 23) to its fully open position (FIG. 24) either by an automatic control 28 (FIG. 1) or by a manual control handle 500 (FIG. 2) of various designs. When the valve 18 is opened, the pressure within the nozzle barrel 16 will drop to near ambient, and beer will flow from the keg 20, through the dip tube 24, the keg connector 26, the beverage flow line 22, an upstream choker connector 23 (described in detail later herein), and the volumetric flow rate controller 14 which is a tube of reduced diameter when compared to the beverage flow line 22. When the beer has flowed through the choker 14, it will then pass through a downstream choker connector 15 and into a downstream beverage flow line 40 which is in turn connected to the nozzle assembly by a connector 42.

The numerical descriptors of various components from FIGS. 1 and 2 are used throughout the application to describe like components with reference to other figures.

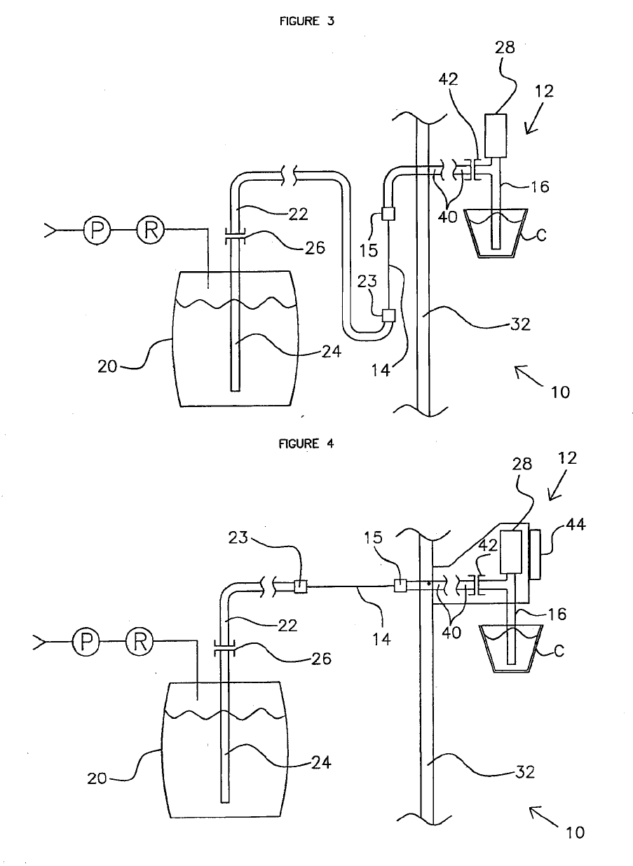

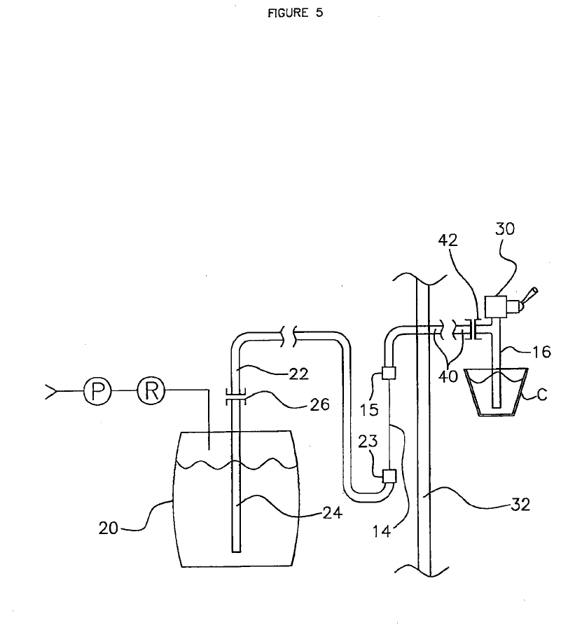

The volumetric flow rate control or controller can be physically separated or spaced-apart from the subsurface positive shut-off dispensing nozzle as illustrated in FIGS. 3-6. In such implementations, the volumetric flow rate control device 14 is located upstream of the nozzle structure 12, and can be located anywhere in the beverage flow pathway between the beverage source 20 (such as a beer keg) and the nozzle 16 itself, and in some practical cases can be well removed from the vicinity of the dispensing nozzle. Thus, as can be seen from FIGS. 3-5, the nozzle assembly 12 can be carried to one side of a wall or vertical mount surface 32, and the flow rate controller 14 can be located on the other side of the wall 32.

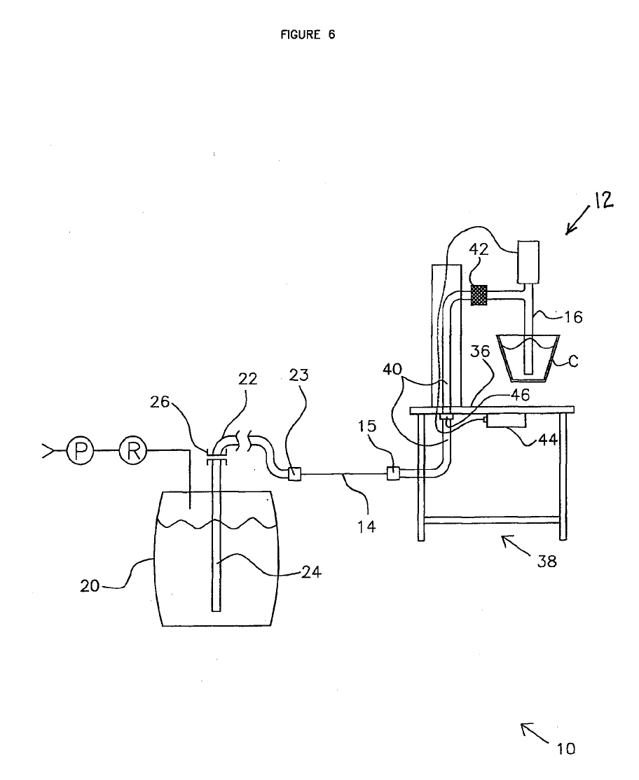

In FIG. 6, a beer tower or dispense tower 34 is shown mounted on a horizontal surface 36 of a counter assembly 38. In this implementation, a downstream beverage flow line 40 extends from the flow rate restrictor 14 through the beer tower 34, terminating at, for example, an industry standard coupling nut connector 42, to which the beverage dispensing nozzle assembly 12 also is connected. The automatic control 28 which caused the shut-off valve 18 to move between open and closed positions is coupled to an electronic controller 44 in a manner which will be described below.

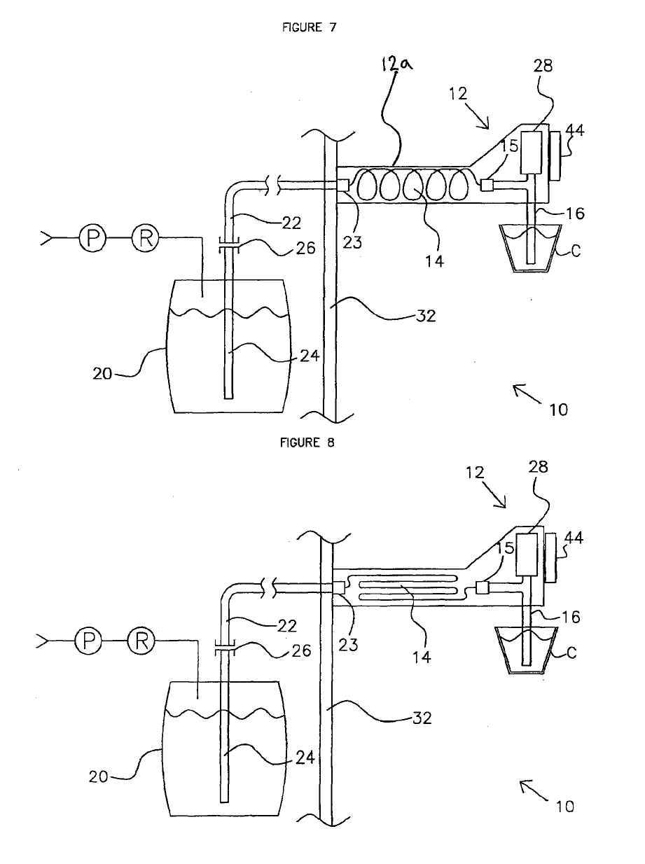

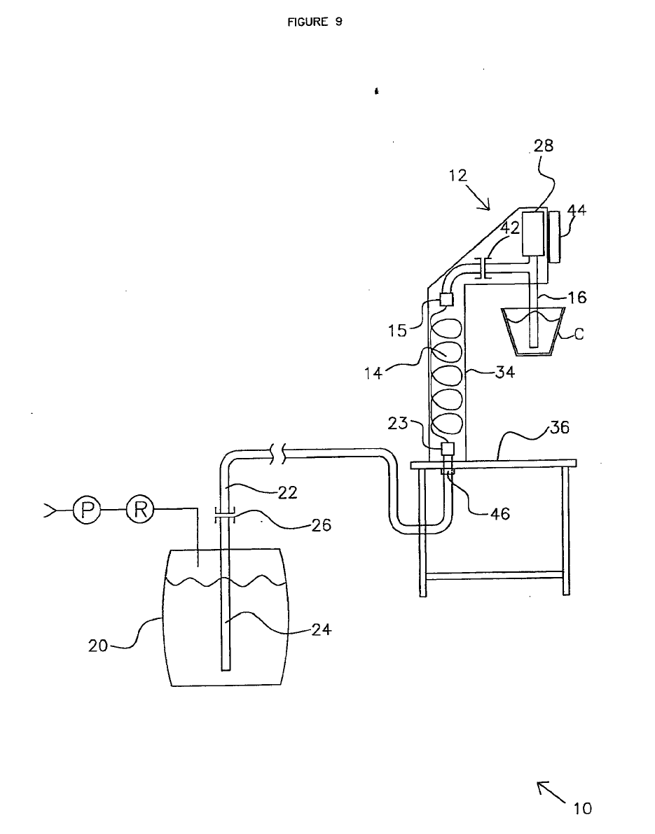

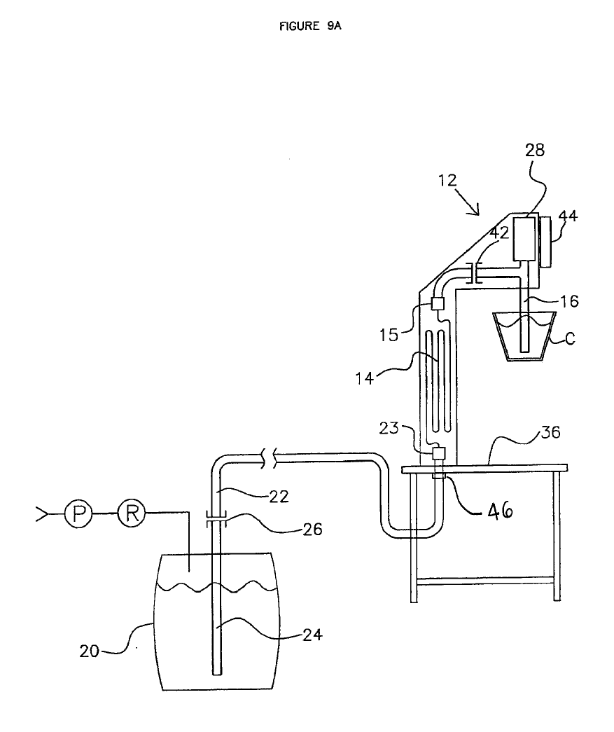

As shown in FIGS. 7-12, the volumetric flow rate control device 14 can be located adjacent to the fitting 42 of the nozzle assembly 12. This allows for integration and packaging of the volumetric flow rate control device 14 into a housing (such as a housing 12aas shown in FIG. 7) which, along with associated controls and the dispensing nozzle, constitutes a complete dispenser assembly. Thus, the volumetric flow rate controller 14 can optionally be sized to fit inside of an enclosure of dimensions that are relatively similar to those found in conventional beer dispensers, and particularly in a housing having dimensions similar to the vertical dispensing nozzle support housing located on the bar or serving counter, and known generically as a beer tower, or dispense tower. Such a beer tower may, for example, be a square structure measuring no more than 12 centimeters on a side, or a cylindrical structure having a diameter of no more than 12 centimeters.

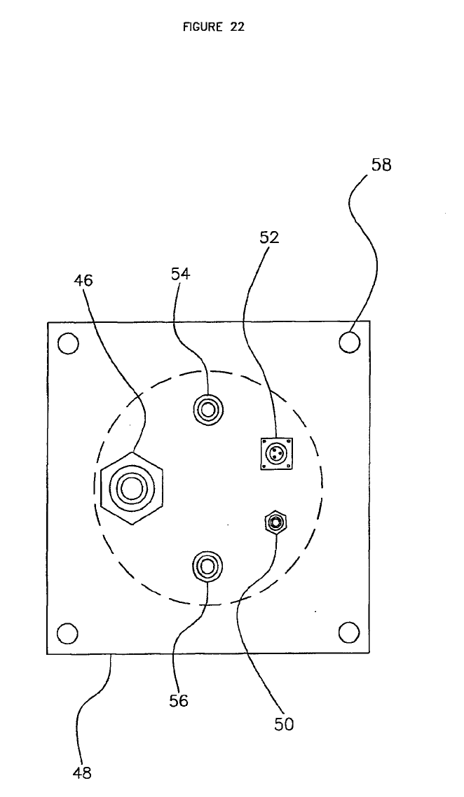

As shown in FIG. 9, one implementation is mountable onto a horizontal surface 36, such as a drinks bar or serving platform, in a manner that is conventional for beer towers of known type. In this implementation, the flow rate control device 14 and the nozzle assembly 12 are entirely contained within the housing (with the exception of the beverage dispensing nozzle which necessarily extends horizontally away from the tower, and also optionally an AC mains plug-in type power supply (not shown) for providing electrical service to the dispenser control electronics). In this arrangement, the flow rate restrictor 14 is coiled within the beer tower 34. However, as shown in FIG. 9A, the flow rate restrictor can be configured in other arrangements, such as in a serpentine fashion. In the coiled arrangement, the coiled flow path of the tubular restrictor is capable of being tightened using a mechanical means, such as a tightening screw (not shown), for example, to generate at least a partial compression of the restrictor 14. The overall purpose of such an arrangement is to allow the beer dispenser to be readily mounted in place of older, conventional dispensers without requiring of significant changes to the existing drink serving layout, and with the new dispenser occupying a space on the bar that is substantially similar to that taken by the replaced tower. As shown in FIG. 9, much of the dispenser is found above the plane of the bar, i.e., the horizontal surface 36, with a suitable beer conduit attachment or pass through or hookup fitting 46 being the only part of the dispenser shown protruding below the bar. In some implementations of the dispenser (see FIG. 22), a bottom mount plate 48 also contains a compressed gas pass through or hookup fitting 50, an electrical supply pass through or hookup connector 52, and coolant supply and return 54, 56, respectively. The mounting plate 48 is also provided with a plurality of mounting holes 58.

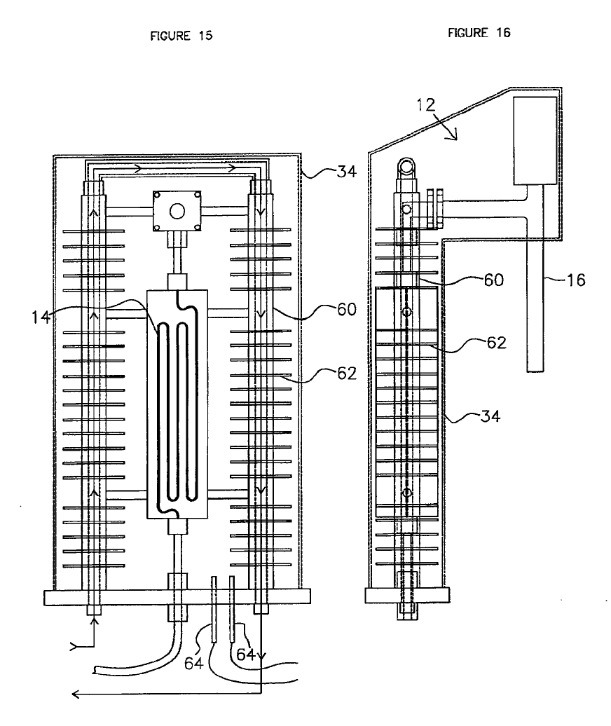

As shown in FIGS. 15 and 16, a beer tower 34 may contain a serpentine flow rate controller 14 as well as most of the beverage dispensing nozzle assembly 12 (again, with the exception of the lower end of the nozzle barrel 16). In this design, the tower is also illustratively shown with an inverted U-shaped cooling tube assembly 60 which are provided with suitable fins 62. The beer tower, optionally may also be provided with one or more temperature sensors 64.

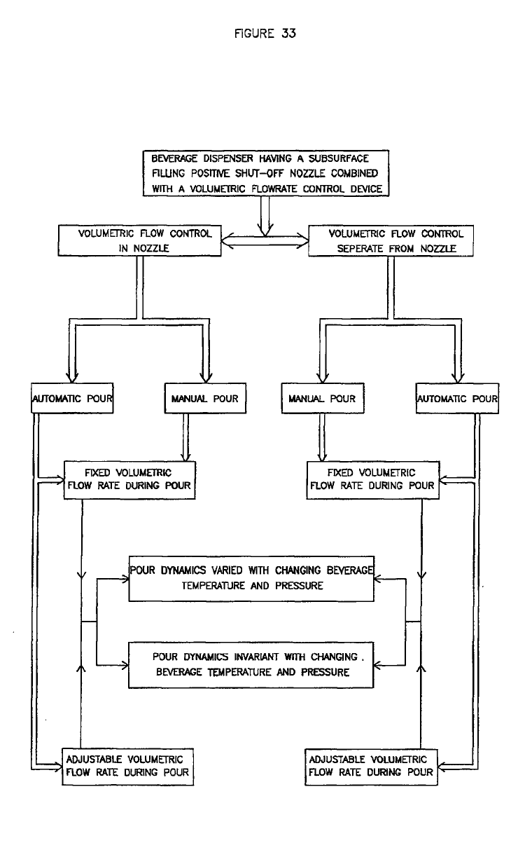

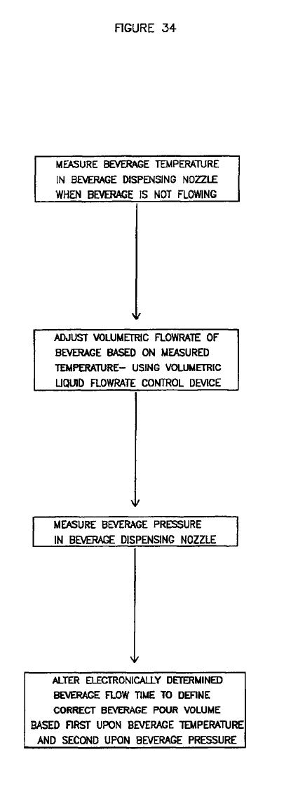

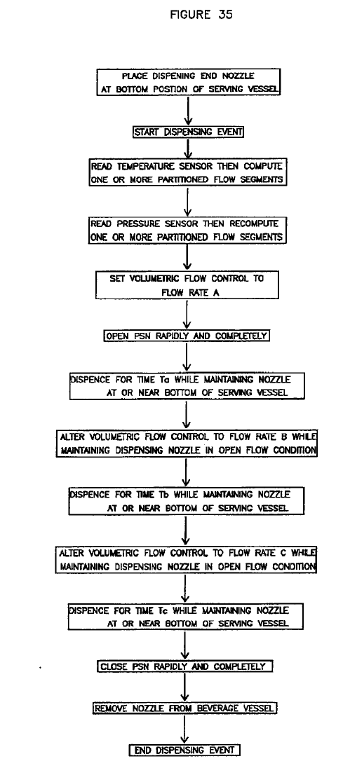

As shown in FIG. 33, both fixed volumetric flow rate units and adjustable versions can be provided with the ability to alter the characteristics and attributes of the beer pour as a function primarily of beverage temperature changes and secondarily as a function of beverage source pressure changes as most often defined by beer keg pressure.

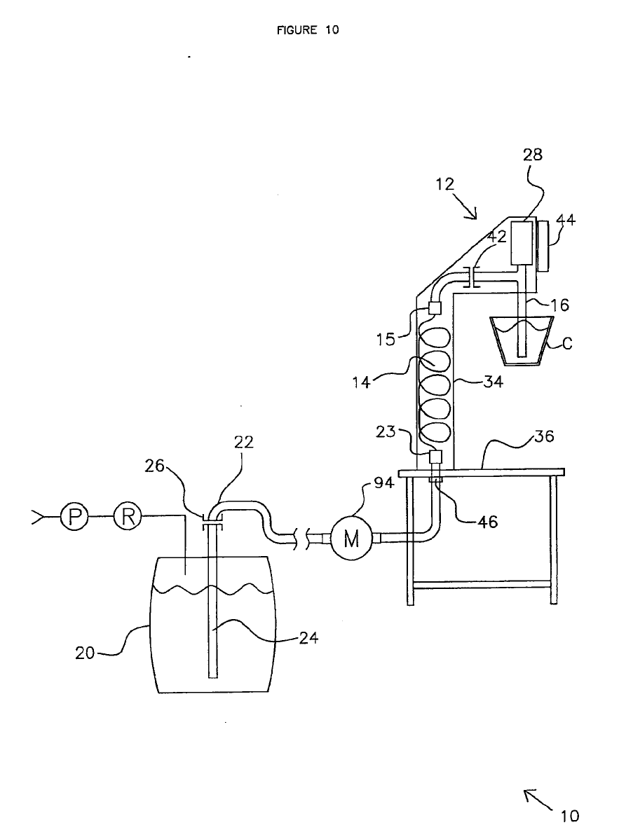

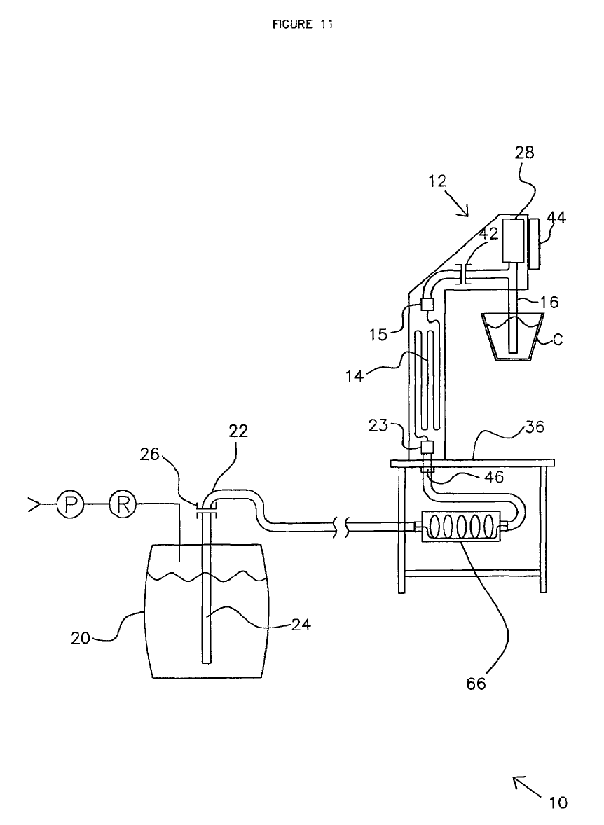

As shown in FIG. 11, a device including a cold water or ice water cooling bath 66 can optionally be located in the vicinity of the point-of-dispense beer faucet, such as under the counter or bar 36. Such a cooling device represents part of the flow pathway or flow conduit of beer to the disclosed dispenser, but does not alter or impede its function or character and one is operable with the other. Alternatively, such a cooling bath or other cooling fluid may be placed in direct thermal contact with the volumetric flow rate control device 14 to regulate the temperature of the beverage in the volumetric flow rate control device 14.

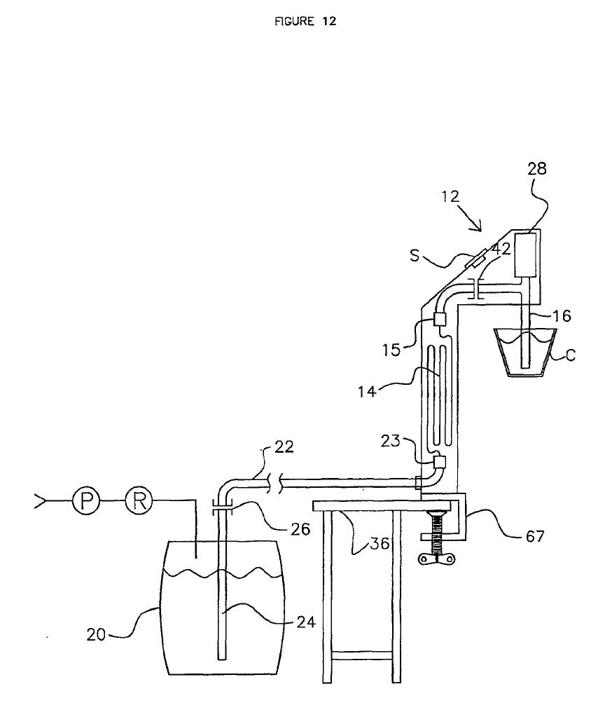

As shown in FIG. 12, the beer tower may optionally be provided with a clamp 67 for clamping the tower onto a bar 36. This design is also provided with an ambient temperature sensor S.

During operation, the beer flow pathway of the beer dispenser is completely filled and the beer is pressurized (typically at the keg) to effect flow. As such, this packed liquid condition shall be referred to as “hydraulic” and describes beer flow without the presence of gas pockets or inclusions in the flow pathway.

When beer flow in the described systems is substantially hydraulic, absent flow through the dispenser liquid flow pathway, the hydraulic pressure at every location in the pathway is the same, and can be estimated as the gas pressure applied to the surface of the beer in the keg (rack pressure). Holding the beer at rack pressure within the dispenser ensures that, over sustained and extended periods of inactivity, the beer remains unchanged without substantial deterioration in quality, flavor, or gas content, and is thus able to be dispensed on demand without significant compromise in beer quality or characteristics.

When flow through the dispenser liquid pathway is allowed, the pressure falls below rack to various different values at various locations within the dispenser apparatus, all dependent upon and defined by well understood liquid flow properties and principles. During flow, the pressure at the outflow port 15 of the volumetric flow rate control device is lower than the pressure at its inflow port 23 and the pressure at the beverage flow outlet of the subsurface filling bottom shut-off dispensing nozzle 16 during flow is at or near atmospheric pressure. After beverage flow through the system is stopped, the various pressures in the system all rapidly return to the stasis condition of rack pressure (assuming that there is no elevation difference from the keg to the nozzle, which is rarely the case). Beverage flow through the dispenser is mediated only by the opening and closing of the subsurface filling positive shut-off nozzle.

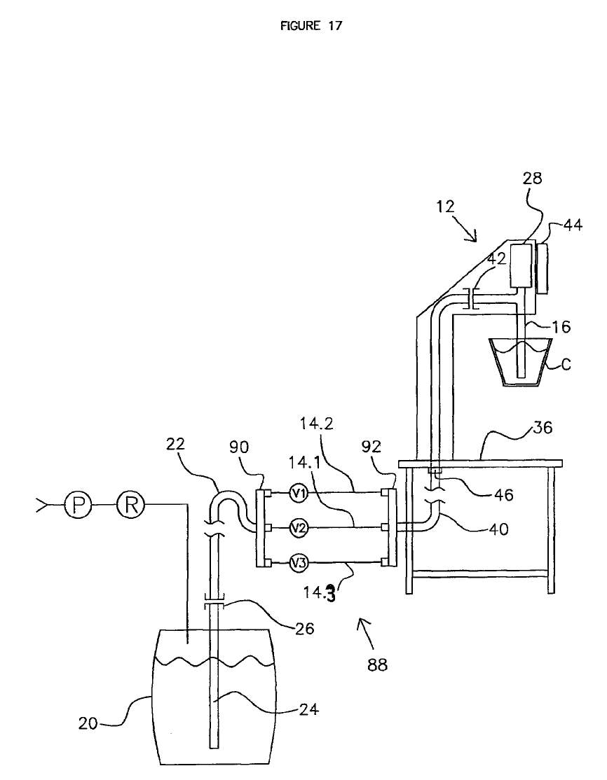

The volumetric liquid flow rate control device serves to restrict, reduce, and thus define and regulate volumetric flow rate once flow is allowed by the dispensing nozzle. Thus, beverage contacting flow valves with the variable flow rate flow restrictor structure (FIG. 17, for example) are only to vary flow rate, not to block flow entirely. Thus, if the volumetric flow rate of beer from the keg 20 at a given pressure were measured without the volumetric flow control device 14 in the beverage flow pathway, and compared with the volumetric flow rates possible with the volumetric flow control device 14 inserted into the same pathway, the volumetric flow rate will be lower or reduced in the latter case.

A dispensing nozzle 12asuitable for use with the described systems is illustrated in FIG. 23. The portion of the nozzle below a tee structure 68 where beverage enters the nozzle from a generally horizontal port 42 shown in (FIG. 1) is termed the nozzle barrel, whereas the structure to the side of the port is called a nozzle inlet 69. The nozzle barrel ends at its lower end in a nozzle tip 70 comprising the nozzle plug 18 and its operator rod 72. A centering spider 74 serving to maintain the plug in a concentric location when opened away from the nozzle barrel (as shown in FIG. 24). As can be seen, the nozzle plug 18 is illustratively conically shaped and is provided with a nozzle plug seal 76 in the form of an 0-ring which is received within a suitable groove (not shown) in the nozzle tip 70.

One illustrative means for moving the valve 18 between its open and closed positions includes a piston 78 which is connected to rod 72, the piston being located within a cylinder 80. The piston is moved up and down by compressed air which is controlled by a 3-position solenoid operated pneumatic control valve 82. The compressed air is typically pressurized carbon dioxide which is used as the beer keg pressurizing gas. The position of the valve 18 is sensed by position indicators 84, 86. The valve 82 and positions sensors 84, 86 are suitably interconnected with an electronic controller 44 (described in connection with FIG. 4). With this arrangement, the time from the start of nozzle actuation for opening, to the time of completion of actuation to a fully open condition, can be defined. This is accomplished by electronically measuring the time interval from the loss of signal of the full close position sensor 84 shown in FIG. 23, to the detection of a signal from the full open sensor 86 as shown in FIG. 23. The nozzle close to open time can be compared with a predefined and engineered time interval, with this comparison allowing each nozzle opening actuation to be checked to verify that the nozzle actuator and opening function are operating correctly.

The time interval for comparison to the actual opening time can be of three distinct varieties. A default time can be checked by the electronic controller 44 with each actuation, this interval being fixed and equivalent to or slightly longer in duration than the worst case full stroke nozzle opening actuation time anticipated (as previously defined). A variable actuation comparison time equivalent to or slightly greater than a computed one percent of the pour time duration entered into the dispenser electronic controller can also be used. The third time-motion analysis value is a specific interval associated with a particular dispensing nozzle size or type. As will be further disclosed, many nozzle shapes and sizes and lengths can be beneficially combined and used with the volumetric flow rate control device. These various nozzles can present different actuation times as a function of their characteristics and thus a nozzle specific actuation time comparison standard can be determined and utilized.

Particular implementations also provide for immediately terminating a particular beer dispensing event in the case where the measured actuation time is too long. This is done in recognition that a pour event where nozzle opening is measured to be slow will likely result in a pour with excess foam, and container overflow, and that such a pour should therefore be stopped prior to completion. Alternatively, the pour time can simply be reduced to accommodate the expected increase in foam, for example to 90 or 95 percent of the predefined pour time.

Measuring dispenser nozzle opening time also allows for the creation of an optional functional alarm. The electronics design can allow an error band to be chosen (for example, T+10% or T+20%) and a last in first out (LIFO) average of opening time can also be utilized in order to limit or eliminate erratic alarming.

Because the full open position of the disclosed dispensing nozzle is sensed and encoded into the control electronics, it will be appreciated that the nozzle can be monitored throughout the beverage dispensing period to assure that the nozzle orifice remains fully open, as may be desired to assure a controlled, predictable, and repeatable pour behavior of the beverage. Should the full open signal be lost as the beer pour progresses, the nozzle can be immediately closed ending beer flow, and an alarm function can be activated.

Using the sensing and comparative arrangements described above, it will be understood that the time interval of nozzle flow aperture closing can also be measured and analyzed for correct operation with each dispensing event in order to assure that an understood, desired, and repeatable nozzle closing motion is assured. The means of analysis and alarming in the case of the nozzle closing motion are essentially similar to those for nozzle opening.

While a pneumatic cylinder is used for operating the valve, other operating devices can be used including linear and rotary electric motors, solenoids, voice coils, permanent magnets, thermal actuators, and the like. Whatever actuator type or form is utilized, encoding the nozzle motion as described allows monitoring of the status of the actuator. This is done by measuring the time from initiation of an open nozzle drive or start signal applied to the actuator and the loss of the nozzle full close sensor signal. This method measures and characterizes the time it takes the actuator to actually induce a defined nozzle motion and this time can be analyzed as previously described. An increase in this time beyond an understood increment can be used to predict excessive actuator wear or near completion of the actuator's life cycle, thus providing early warning of malfunction or wear of this beer dispenser component. An excess actuation time can also diagnose nozzle sticking due to a problem with the nozzle actuation rod or plug or plug seal.

As with all function checks, operating analysis, and functions available and implemented in the operation of the dispenser, the nozzle motion and alarm checks can be made with or throughout each dispense event and logged as accessible data within the nonvolatile memory of the dispenser electronic controller and can be accumulated on a last in first out (LIFO) basis.

Alternatively, the dispenser system can be operated on a manual basis, where a pour (beer flow) is initiated by an operator and is stopped by an operator. Complete and rapid nozzle opening and nozzle closing is as important in manually operated dispenser systems as in automatically operated systems. Hence, in manual systems, while the manual flow actuator can have the appearance of the traditional beer handle associated with known beer faucets (as one example), the actual physical action of the beverage nozzle is mechanically or electronically defined to comprise complete and rapid opening or complete and rapid closing, without operator ability to alter or manipulate or control the nozzle flow aperture to any intermediate position or actuation speed. Thus, as with the automatic versions of this beverage dispenser, the flow and actuation properties and characteristics of the subsurface filling bottom shut-off nozzle can be referred to as digital or binary, where flow is either on or off and the change in state is rapid and defined, and where these properties and characteristics are intentionally and purposefully embodied in the apparatus.

The dissolved gases at or near saturation levels in hydraulically confined beer remain in solution (where the body of liquid is relatively bubble free) at typical beer temperatures and pressures unless substantially agitated or subjected to turbulence or reduced in pressure or increased in temperature. The volumetric liquid flow rate controller described herein, over a range of conventional beer dispensing temperatures and pressures, is capable of widely modulating volumetric flow rates without creating any localized or cumulative differential pressure drop sufficient to induce or cause dissolved gases in solution in the beer to leave solution and enter gas phase. Thus, the volumetric flow rate control device exhibits low or minimal flow turbulence across a flow control range, both fixed and dynamic, that is sufficient in volumetric flow range to be useful in the controlled and rapid dispensing of beer or other beverages. Within the range of general volumetric flow rates and other conditions previously discussed, the volumetric liquid flow rate controller described herein has a linear beverage contact or beverage bearing pathway that is generally no longer than 100 centimeters in length from point of beverage entry into the device to point of beverage exit from the device, and is capable of selectively modulating these volumetric flow rates without causing or inducing the formation of gas bubbles in the beer flowing through it. Another attribute of the disclosed volumetric flow rate control device is its design and construction in accordance with sanitary design and cleaning standards. An example of these standards are those promulgated in the United States by the National Sanitation Foundation (NSF).

Further to quantifying a suitable volumetric flow rate control device for altering or setting an acceptable draft beer volumetric flow rate through the draft beer dispenser flow pathway, a device operable inclusive of all noted criteria over a range of 0.75 ounces (approximately 22 milliliters) to 4.0 ounces (approximately 120 milliliters) per second is suitable. This range of flow rates, when used with a system such as is described herein, allows the dispenser to produce a US 20 oz. pour (approximately 600 milliliters) in 5 seconds or less with substantially complete control of all liquid flow characteristics and parameters and including an ability to intentionally define the amount of beer foam comprising the head on the poured beer, and including an ability to reproduce the defined pour over and over again.

Another limitation of certain hydraulic volumetric flow rate control devices is their inability to control volumetric flow rates of beer and other gas solvated beverages without causing substantial quantities of gas to leave solution as a function of their use to reduce and control flow rates. Essentially, the very nature of these conventional point control flow rate devices causes their use to generate outgassing in beer (foam) that makes their use unworkable. This is because a pressure change in a gas saturated or gas solvated liquid alters the solubility and saturation curves, which can cause the gas to leave solution and enter the gas phase. Thus, when conventional devices are “turned down” or restricted in their internal flow pathway adequate to create useful and usable volumetric flow rates in a draft beer dispenser, gas entrained flow at the device output is the result. Dispenser systems such as are described herein address this limitation and allow bubble-free flow to the subsurface beverage dispensing nozzle.

The controller 14 shown in FIG. 1 has internal flow diameter as measured at the flow input or output that, in ratio to the length of its liquid flow pathway, has a ratio that typically does not exceed 160:1.

In addition to the passive, single long tube flow restrictor 14 as pictured in FIG. 1, choker tubes can be combined in various ways as shown in FIGS. 17-19, to allow dispenser implementations where the flow rate of beverage from pour to pour or during a pour can be automatically modified or altered as desired, and as extensively discussed herein. By series (e.g., FIG. 18) or parallel (e.g., FIG. 17) arrangements or a combination of both, multiple choker tubes of desired lengths and diameters can be combined with flow control valves (on or off) of any suitable type to allow different volumetric flow rates of beverage.

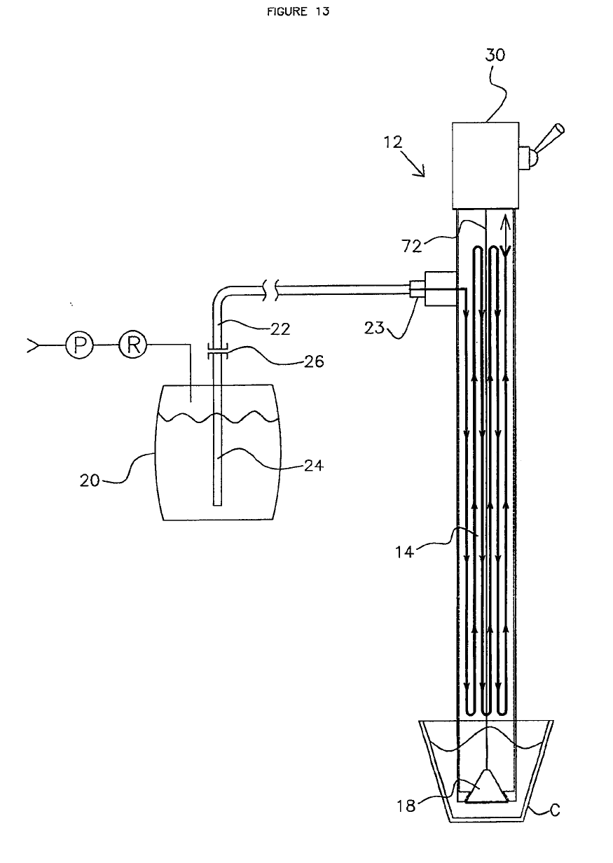

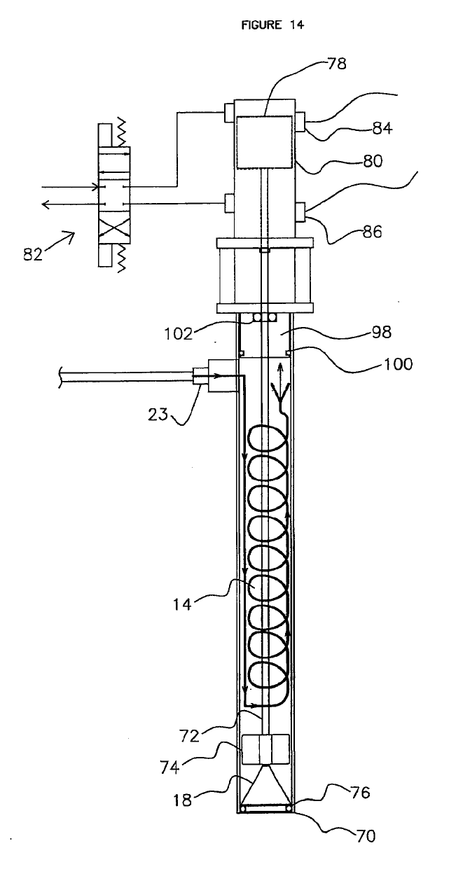

FIGS. 13 and 14 depict adaptations of rigid structure versions of the choker volumetric flow control devices. FIG. 14 depicts a passive flow control adapted for service inside of the barrel of the subsurface filling bottom shut-off beverage dispensing nozzle as a coiled form. (As depicted in FIG. 23, the barrel is hollow where a volumetric flow rate control or controller is used external to the dispensing nozzle). In this beer dispenser implementation, this available space is simply used to good advantage to house a coiled or serpentine form (FIG. 13) of the volumetric flow rate controller.

In operation, when the beverage subsurface beverage dispensing nozzle is opened by an actuator, such as actuator 28 or actuator 30, beverage is allowed to flow through the shaped choker within the nozzle barrel, emerging at the discharge end, which is often formed into a conical flow diffuser. The beverage emerging into the nozzle barrel lumen then flows out of the nozzle in the manner fully disclosed elsewhere in this specification.

Where the flow rate restrictor 14 is used to define a single and fixed volumetric flow rate of beverage during the beverage dispense pour time, it can be empirically demonstrated that at a given beer temperature and beer keg or rack pressure, a 600 milliliter dose of a test liquid such as water is repeatable at least to within plus or minus two percent of the beverage dose mean as defined by the dose data sample group. Further, it can be empirically demonstrated that this repeatability within a test sample data group is possible over long time periods such as days, weeks, or months without a requirement to change the volumetric flow rate control device.

In the instance where a flow controller of the type described herein is used to define two or more volumetric flow rates of beverage during the beverage dispense dose time, it can be empirically shown that at a given beer temperature and beer keg or rack pressure, a 600 milliliter portion of a test liquid such as water is repeatable at least to within plus or minus two and one half percent of the beverage portion mean as defined by the dose data sample group, and that such repeatability within a given test sample data group is stable over long periods of time.

Flow begins with the nozzle placed at or near the bottom of the beer glass (here synonymous with all other serving container types), and the opening of the nozzle in the particular manner previously described. Beer flow ensues immediately with nozzle opening and its flow results in the formation of a definite and relatively limited amount of foam, which can be observed to be determined principally by nozzle size and the volumetric flow rate of beer as established by the volumetric flow rate control, and to diminish sharply in rate of formation as the level of beer flowing into the glass reaches and then rises above the flow aperture of the nozzle. As beer flow continues, constituting most of the delivered volume of beer defined to be the pour (typically 90 percent or more), very little additional foam is formed in the beer since the beer flowing out of the nozzle flow outlet is largely free of bubbles, and the flow turbulence induced by nozzle outlet flow is at comparatively low velocity and widely dispersed away from the entire circumference of the nozzle and is occurring on a subsurface basis such that no atmospheric gases are churned or folded into the beer. Under these conditions the rising surface of the beer can be seen to typically be substantially placid. At the end of the pour period, the desired portion of beer has been dispensed and the nozzle is rapidly and completely closed as previously detailed. The nozzle remains at or near the bottom of the beer glass throughout the pour, and as it closes a definite and short duration flash of foam is observed. This quantity of foam is directly associated with closing of the nozzle as previously explained and, with a given set of nozzle motion parameters, can be empirically demonstrated to vary directly as a function of the volumetric flow rate of beer from the nozzle at closing, such that the higher the volumetric flow rate allowed at nozzle closing, the greater the amount of foam formed.

This mode of pour is described here in this detail to illustrate that three separate events cause three separate quanta of foam to be formed and defined, each of which is quantifiable and repeatable from pour to pour to define the total amount of foam formed on the beer poured.

With this single volumetric flow rate pour method, the height of a foam layer or cap formed on top of a given beer under stable conditions of temperature and keg pressure is highly repeatable such that one beer will look essentially the same as the next. This high degree of repeatability is greatest when dispensed volume is automatically defined, but even in a manual dispense implementation, the amount of foam generated is highly repeatable, in part due to the precise, digital open-close motion of the beverage nozzle.

With this single volumetric flow rate pour method detailed here, the amount of foam to be generated on top of the beer at the end of the pour can be directly and substantially controlled. This is done by simply adjusting the flow rate restrictor, thus altering the volumetric flow rate of beer flowing from the beverage nozzle outlet such that higher flows give more foam, while lower flows give less foam.

To illustrate the direct correlation between foam formation and volumetric rate of dispense flow of a typical United States or European lager (over 50 versions have been directly tested by the inventors) poured as a US 20 oz. beer (approximately 600 milliliters) can be dispensed into virtually any shape beer glass in six seconds with the generation of a foam head insufficient to completely cover the top surface of the beer at the end of the pour. Further, progressively greater amounts of foam can be generated as desired as volumetric flow rates are increased until, by example, a foam head equivalent to one centimeter is achieved repeatably on the surface of the beer at a dispense time of 4.5 seconds. By way of comparison, a typical US 20 oz. pour of a draft lager from a conventional tap typically takes anywhere from 12 to 20 seconds and the foam head is not defined or definable from beer to beer by any known means. Thus, with a pour based upon a single volumetric flow rate, the task is completed two to three times as fast.

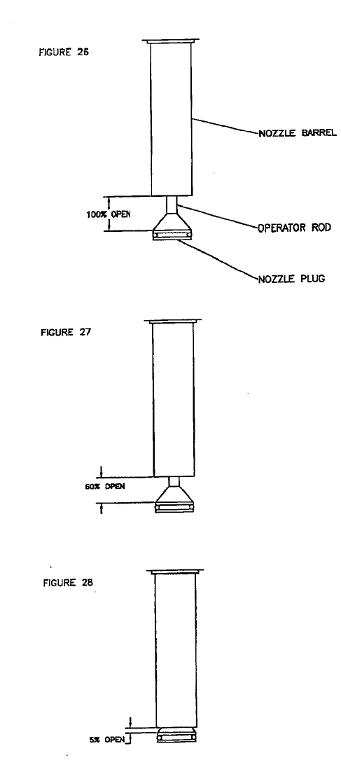

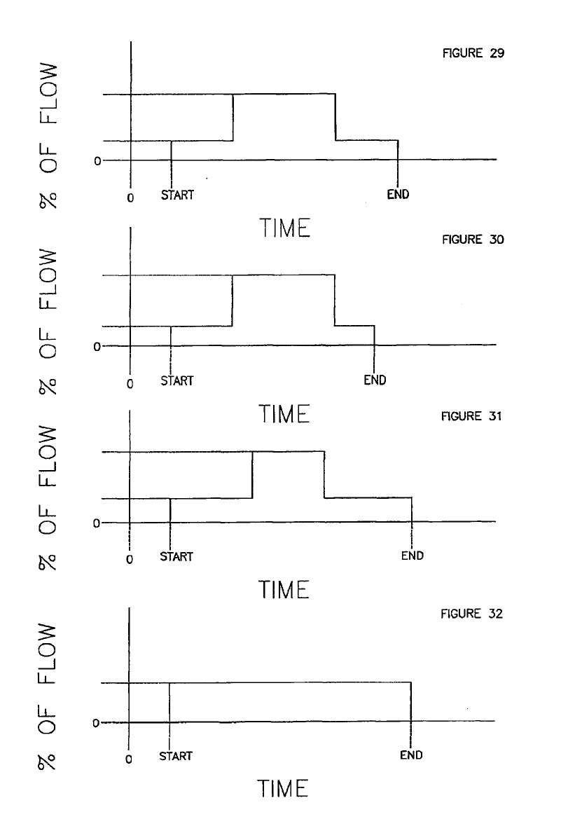

The use of a volumetric flow rate controller of the types shown in FIGS. 17 to 19 allows the volumetric flow rate, as measured at the beverage nozzle outlet, to be varied or profiled, or subdivided. FIGS. 29 to 32 illustrate the effects of this volumetric flow rate variability capability. Essentially, many different flow rates can be achieved during a beer pour, but as a practical matter typically only two or three are necessary to optimize the characteristics of a beer pour to achieve a fast, highly controlled and repeatable result with any desired amount of foam.

The manner of flow rate change during a beer pour effected by a volumetric flow rate controller is herein referred to as flow partitioning, in recognition that flows are altered at a rapid rate resulting in clear boundaries between successive selected volumetric flow rates.

In operation, with a flow controller being utilized to define volumetric flow rates measured at the beverage nozzle outlet, a typical pour begins with nozzle opening at or near the bottom of the beer glass as previously described. Typically however, prior to nozzle opening the volumetric flow rate controller has been automatically configured in such a way as to initially produce a comparatively low volumetric flow rate of beer upon nozzle opening. Thus, with reference to FIG. 17, a volumetric flow rate controller 88 is illustrated which may vary the volumetric flow rate. The controller 88 includes an inlet and outlet headers 90, 92 respectively, connected to upstream beverage flow line 22 and downstream beverage line 27. A plurality of reduced diameter flow tubes 14.1, 14.2, 14.3, etc., are connected to the inlet header 90 and outlet header 92. Each flow tube 14.X has the same reduced diameter throughout its length. However, the various flow tubes may be of differing diameters or different lengths. Thus, the volumetric flow rate through a flow restrictor can be varied by removing or adding to the flow length of the flow restrictor tube. Alternatively, different diameter flow restrictors will have different volumetric flow rates. Each reduced diameter line is provided with a valve, valve VI for line 14.1, valve V2 for line 14.2 and so on. While three lines are shown, there may be any number. The various valves are controlled by the electronic controller and may be moved to and from closed and open positions. The valves when open present a low turbulence pathway. Thus, a low volumetric flow at the start of a pour generates a minimal amount of foam, but an amount that can be controlled and defined as desired by the user specified configuration of the dispenser. The reduced diameter tubular volumetric flow rate restrictor can optimally be coded with identifying indicia, such color coded, so that it can be readily identified as to its flow reducing characteristics, thus aiding identification and selection for a particular beverage flow requirement, and readily allowing visual checking in an already installed system, and allowing use of the code as an identification in a dispenser installation specification or record or as a dispenser operating parameter in the electronic controller of the dispenser. The reduced diameter tubular volumetric flow rate reducer can be marked or scored at regular intervals, such as every inch or centimeter, in order to aid length sizing to achieve a desired length which correlates directly to a desired pressure drop caused by the tubular reducer, thus establishing a desired volumetric flow rate of beverage from the bottom shut-off subsurface beverage dispensing nozzle.

Typically, the start of pour volumetric flow rate is maintained until the beverage flow outlet of the nozzle is subsurface or below the level of the beer. After this has been accomplished, the electronic controller automatically changes the volumetric flow rate of beer from the nozzle, most typically to a substantially higher flow rate by opening valves V2 and/or V3. This substantially higher flow rate allows the largest volumetric fraction of the beer dispense portion to be achieved in a comparatively short period of time, thus speeding up the entire pour by compressing the time required for dispense. By example, 80 percent or more of the total beer dispense volume may flow into the glass at this second flow rate. As the transition in flow occurs from the first stage to the second stage, the change is comparatively rapid and abrupt, but does not cause foaming or gas breakout in the beer flowing through the apparatus.

At the end of the beer pour the nozzle is rapidly and completely closed, and in preparation for closing, a third volumetric flow rate may be defined by the flow controller. This third flow rate is most typically a rate significantly below the second, and it may be equivalent to the first initial flow used at the start of the pour, but can be discretely and separately established as desired.

Thus, with this third and typically lower flow rate established, the nozzle is closed and the pour completed. As previously explained, the amount of foam generated in the beer glass as a function of nozzle closing is dependent upon the volumetric flow rate at closing and thus controllable using this flow manipulation method.

The particular flow partitioning explained above is only an example of what may be achieved as necessary or desired to define the pour characteristics of a particular beer. The number of flow rate partitions, their flow rate value, and their duration can all be independently established using a volumetric flow rate controller assembly and the electronic controller associated with the dispenser.

Whether the single volumetric flow rate pour method is utilized, or the multiple flow rate pour method is utilized, beer foam is not made or pre-made or formed within the beverage flow pathway during dispensing for the purpose of depositing such foam into the beer glass with the poured volume of beer. Rather, the foam head on the top of the beer at the end of the pour is defined and made only within the glass itself using the volumetric flow rate control techniques disclosed, and the dispenser is particularly designed not to generate bubbles or foam in its beverage flow pathway during beverage flow.

Another attribute of the disclosed beer dispenser concerns the location of formation of the bubbles within the beer glass that ultimately constitute the foam cap on a beer pour from the apparatus. During a beer pour conducted using a dispenser such as is described, the beverage dispenser nozzle remains at or near the bottom of the glass for the entire pour. The merits of this have been substantially discussed, but keeping the nozzle outflow at the bottom of a beer glass yields an additional benefit. With the nozzle subsurface during nearly the entire pour (typically for 90 percent or more of the dispense volume), and particularly at the end of the pour, almost all of the bubbles contributing to the foam head are formed subsurface and near the bottom of the glass. As a result, the bubbles are smaller and uniform in size, and remain smaller and uniform even when they reach the top surface of the beer. This, in turn, contributes to the formation of a foam head with small tightly packed bubbles. This provides a creamy and uniform foam appearance which is often prized among draft beer experts, and the small bubbles are more resistant to rupture and dissipation, thus allowing the foam head to persist for a longer period of time, which is also considered meritorious among draft beer drinkers.

The volumetric flow rate controller can be used to alter the volumetric flow of beer from one pour to the next. This is most typically done in response to changes in the beverage dispense conditions, such as changes in beverage temperature and beverage pressure.

Changes in the dispense temperature of draft beer are a reality of the dispense environment. For example, beer is often kept cold in walk-in coolers that are also used for other purposes such as food storage. Thus, frequent and unpredictable entry into these coolers changes the beer temperature. Further, known draft beer flow lines and dispense towers and faucets all increase in internal temperature as ambient temperatures increase or simply as a dispenser sits idle between pours.

As with temperature, the gas pressure applied to draft beer kegs, which is most frequently the source of the propulsive force in draft beer dispenser flow, is typically variable. For example, the mechanical analog pressure regulators used to establish and maintain the gas pressure on a keg are generally adjustable only to within one or two PSI of desired setpoint, and the gauges used are only accurate to within one or two PSI. These pressure regulators are limited in their regulation capability by factors such as mechanical hysteresis, temperature induced changes and mechanical wear.

Changes in draft beer temperature are well known to change the pour characteristics. As temperature increases, the solubility of gases in the beer, particularly carbon dioxide, decreases. Thus, for a given volumetric flow rate and/or flow velocity, the amount of foam generated as a consequence of dispensing the beer increases as temperature rises. Because this is true, and because the described draft beer dispenser is able to manipulate volumetric flow rates and hence flow velocities, methods of accommodating beer temperature changes in connection with the disclosed dispenser are now described.

Adjusting for increases in beer temperature, on the simplest level, can be done by electronically recording the elapsed time since the last pour occurred, and reducing the net volumetric flow rate of beer on the next subsequent pour accordingly. This volumetric flow rate adjustment versus time adjustment may be formatted in several ways. As the invented dispenser remains inactive, the beer held within the dispenser itself tends to increase in temperature, particularly within the nozzle barrel. This rate of rise, absent active cooling provisions, is predictable based upon generally expected ambient temperatures in which the dispenser will operate. Thus, the electronic controller 44 of the dispenser marks the time from the last dispense event to the next dispense start signal and adjusts the volumetric flow rate controller to reduce the volumetric flow rate as beer temperature increases and then, in the case of a timed flow defined dose, adjusts the pour duration time. Where a flow meter 94 (FIG. 10) is utilized to define the beer pour dose size, as is possible with all implementations of the invented beer dispenser, the pour size is maintained by the flow meter with the change in volumetric flow rate. These adjustments can be done in increments, such as at one minute intervals, five minute intervals, and so on. The changes in volumetric flow can be non-linear or incremental, as can the time interval markers, all of which can be defined by experimental measurements and software design. When this simplified method of beer temperature compensation is used, two additional adjustment features can be included. First, because the dispenser beverage flow pathway will cool back down toward the beer source temperature with each dispense event following a prolonged standby period, provisions are made to readjust the volumetric flow rate back upward as dispensing pours resume, and this can be formatted in a way generally similar to that used with rising temperatures. Second, an alarm function can be implemented where a dispense is not allowed after a period of dispenser inactivity exceeding a certain duration. It is understood that beyond a certain upper temperature, draft beer can become so foamy that a satisfactory pour from a particular nozzle is not possible regardless of volumetric and velocity flow rate adjustments. Thus, in this case, such a condition is inferred as a function of time. This approach prevents a bad pour and the waste and mess that could result. When such a time based alarm is used, the dispenser electronic controller forces the operator to conduct a brief re-prime of the system to re-cool the dispenser or the electronic controller allows a reduced volume dispense dose for the same purpose. In this second case, overflow is prevented, and the short pour can be manually topped up to a full measure.

The effectiveness of adjusting the volumetric flow rate of the beer pour as a function of time since the last pour as a means to maintain a desired set of pour characteristics with increasing beer temperature can be enhanced by sensing the ambient temperature in which the beer dispenser is operating. It is understood that the warmer the ambient temperature in which the dispenser is operating, the more rapid the increase in beer temperature when it is in a standby condition. Thus, knowing the ambient temperature allows the dispenser system electronic controller to alter the amount of adjustment of volumetric flow per unit of elapsed time between pours with greater precision than when relying on elapsed time only.

A refinement of either time based method of beer temperature compensation, and of the several additional methods to follow, improves flow parameters compensation further. In this refinement, the beer volume of the lumen of a particular size nozzle is known to the electronic controller, as is the set pour volume to be dispensed. This allows a ratio to be struck that is indicative of the amount of warm beer that will enter the beer glass as a fraction of a total pour dose, because the beer in the nozzle warms more quickly and to a higher temperature than the beer in the beverage flow pathway upstream of the nozzle. Thus, the average temperature of the beer poured after a prolonged dispenser standby period is a function of nozzle size and the electronic controller can adjust the magnitude of volumetric flow rate or other pour parameters compensation for temperature accordingly, including the pour duration required to define the correct pour volume at the changed flow rate.

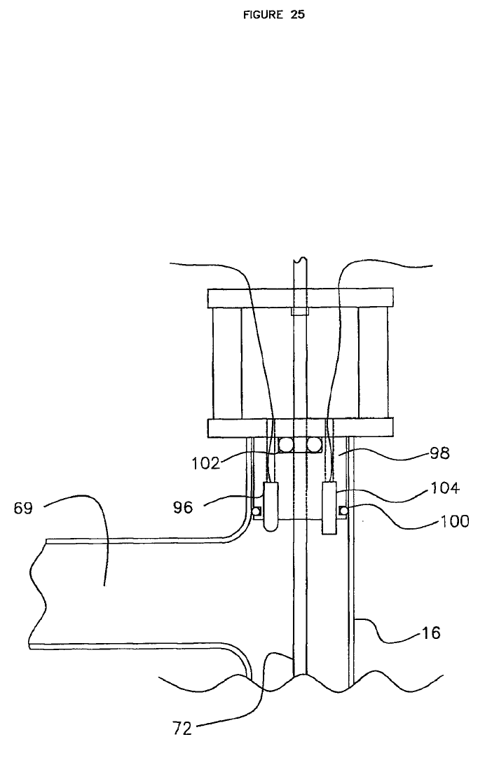

The volumetric flow rate of the beer being dispensed with changing beer temperature can be defined as a function direct sensing of beer temperature. This can be accomplished using a suitable temperature sensor 96 directly measuring the temperature of the beer in the subsurface filling bottom shut-off beverage dispensing nozzle as shown in FIG. 25 . As shown, the sensor is illustratively mounted into the dispensing nozzle top displacement plug 98 which carries a seal 100. This sensor location is suitable in that it allows a sensing location that immediately senses inflowing beverage temperature, and, in a prolonged standby condition the location gives an internal nozzle volume beer temperature that is indicative of the actual temperature gradient of the beer in the vertical nozzle barrel. Another advantage of this location is that, in the event of sensor failure, the entire top seal plug can easily be removed and replaced, effecting a simple change out procedure for maintenance personnel. As can be seen, the nozzle plug operating rod 72 passes through a suitable aperture (no number) in the plug 98, and is suitably sealed by operator rod shaft seal 102.

With in-nozzle temperature sensing, an accurate temperature reading can be taken prior to each commanded pour. This reading, processed by the electronic controller, can be directly used to alter the volumetric flow rate of the beer flowing into the glass as the beer temperature changes. This alteration maybe up or down, depending on the direction of temperature change. As in the previous cases, the alteration in volumetric flow rate allows the pour characteristics, as previously established, to be maintained, and in particular the amount of foam on the poured beer.

In the instance where the pour volume is defined by timed flow of beer at a set rack or system pressure, and the volumetric flow controller has altered the volumetric flow rate as a function of beer temperature, a new pour time can be established by the electronic controller. This is readily accomplished since the incremental change in flow rate can be known by the controller such that the time of flow adjustment directly follows from the volumetric flow rate adjustment following from the temperature measurement.

The volumetric flow rate controller offers a predictable flow rate for each physical increment or position of adjustment. Thus, the electronic controller can alter pour time to maintain pour volume by direct measurement of the flow position of the flow controller (by any suitable feedback mechanism, such as an encoder or resolver or potentiometer or position sensor or the like), or by knowing the flow rates at various pre-defined flow controller positions, which can be entered as calibration variables into the controller, by example or established mechanically. In this case, it is also readily possible to construct a series of data tables wherein the change in beer temperature measured causes a new beer pour setup, consisting of all necessary pour parameters, to be entered into the electronic controller. This is done incrementally so that the number of pour setups needed is relatively small and easily managed.

By way of illustration of a particular version of the above described temperature compensation method, consider a simple beer pour setup wherein an initial flow controller defined low volumetric flow rate is used during nozzle opening, followed by a high flow rate, followed by a nozzle closure low flow rate the same as the first low flow rate, all in the manner previously detailed. With an increase in temperature, the low flow rate at nozzle opening can be maintained for a longer period for more gentle flow prior to the high flow portion of the pour. Since warmer beer is more foamy, the longer period of low turbulence flow makes less foam. Since the total foam cap is the sum of the foam generated at each flow rate, the total foam is reduced to a level desired and influenced by the beer temperature. Following this example further, with further warming of the beer, the nozzle opening first low flow period gets incrementally longer, further offsetting the higher foam characteristics of the still warmer beer, holding the foam cap within acceptable limits. More sophisticated versions of these volumetric flow changing combinations may also be employed. With each change in volumetric flow rate or rates, the dose flow time is readily altered to maintain the correct portion, based upon a previously defined keg pressure. In the instance where a flow meter is used in the beverage flow pathway to define the pour size, the dose is automatically maintained using the flow meter based flow rate signal, generally consisting of a variable frequency pulse train.

With the use of a temperature sensor, an over-temperature alarm function, operating as previously described, is implemented.

FIG. 25 illustrates a second in-nozzle sensor 104, for measuring the hydraulic pressure of the beer in the nozzle. This pressure, measured when flow through the beer dispenser is not occurring, will vary directly as a function of variations in the gas pressure applied to the beer at the keg, which can vary frequently and unpredictably as previously discussed. Knowing the actual pressure of the beer from pour to pour provides a powerful tool in keeping the desired beer pour characteristics constant, and in assuring beer pour volume setpoint stability as pressures vary. Because this disclosed beer dispenser has the ability to rapidly and precisely alter volumetric flow rates, the pressure sensor allows the electronic controller to directly alter flow rates to maintain the desired volumetric flow into the beer glass, even as the motive force for that flow, keg pressure, varies. This, in turn, assures that the time flow defined volume remains correct and that the desired flow rate into the glass gives the desired foam finish on the completed pour.

As previously discussed in regard to temperature changes, beer pressure changes can be subdivided into increments with a lookup table or grouped data set for each increment, allowing simplified “digital” automatic adjustment of beer volumetric flow rate or pour time as a function of pressure.

Because a temperature sensor, a pressure sensor, a volumetric flow rate controller, and an electronic control can be combined in the disclosed dispenser, the dispenser can compensate for variations in these parameters. Thus, prior to the start of each commanded pour, beer temperature may be first measured and the net volumetric rate of beer for the upcoming pour adjusted. Then, the beer pressure may be measured, and the dose time adjusted to assure that the correct pour volume measure is delivered. All of these data, and particularly the temperature, pressure, and volumetric flow rate data, can be used to construct pre-defined flow rate and flow time combinations structured as sequential use lookup tables.

The use of temperature and pressure sensors allows the electronic controller to supervise and manage an alarm function for these variables. In both cases, minimum and maximum values can be set, reflecting a band width within which beer can be dispensed with satisfactory results.

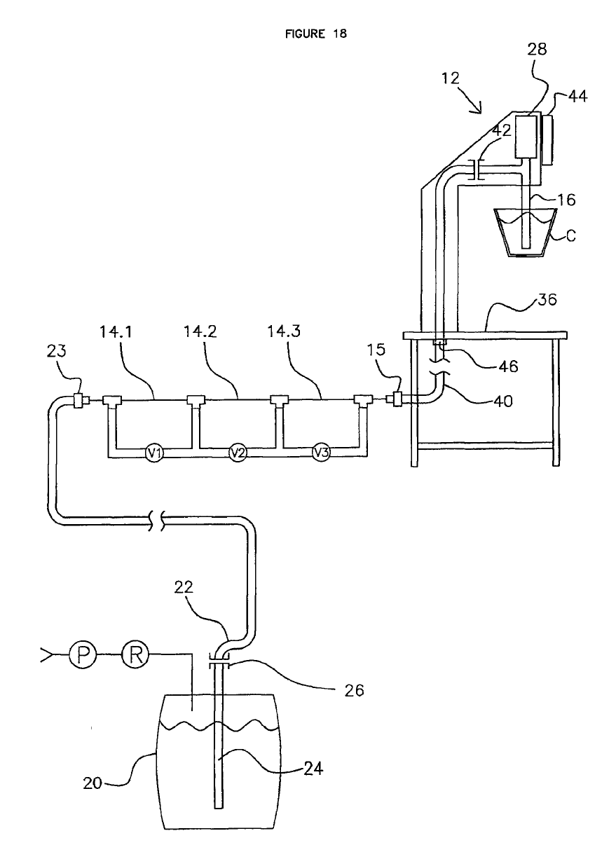

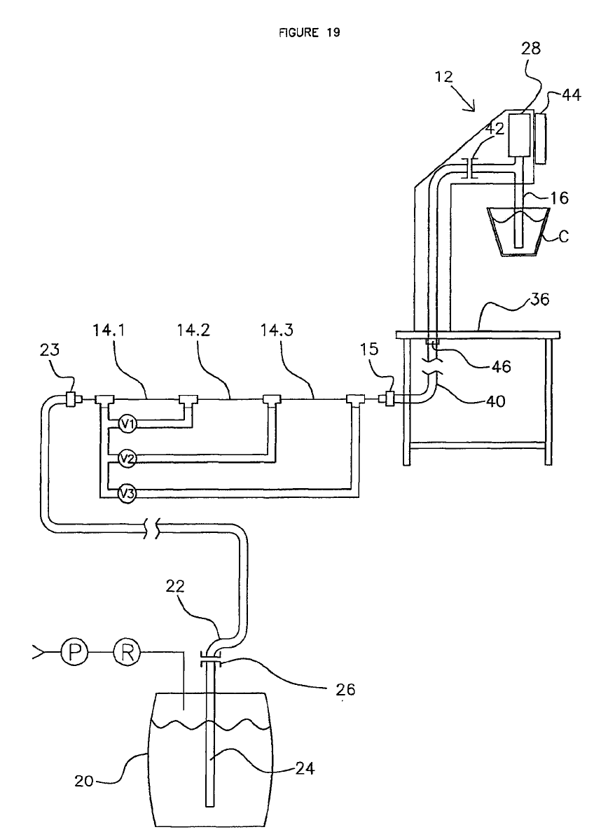

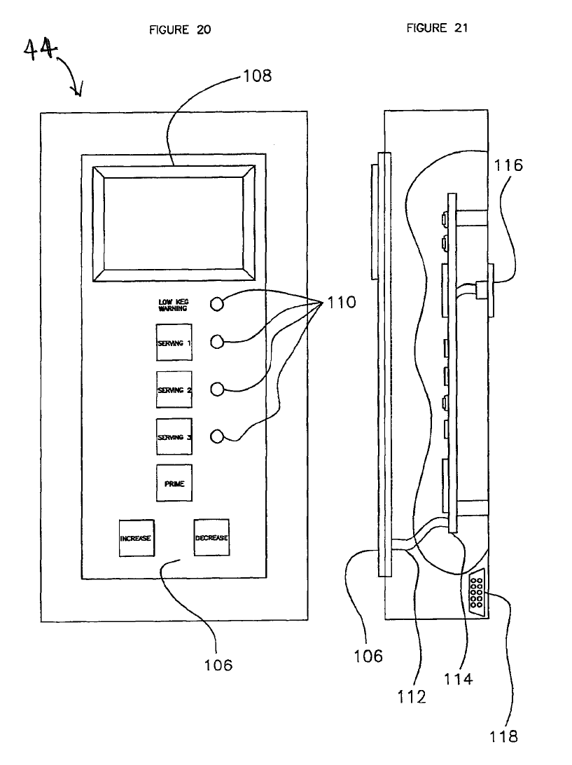

The electronic controller 44 is best shown in FIGS. 20 and 21. It has, in the illustrative implementation, control functions, data grouping functions, data logging functions, computation functions, input-output functions, alarm functions, and maintenance functions. The controller can include a membrane key pad 106 and a display 108 on its exterior. Lights 110 may also be provided to indicate various status. A ribbon cable 112 connects the membrane key pad and display with a printed circuit board 114. An external data input/output port 116 is provided, along with a dispenser input/output connector 118.

The electronic controller can configure the beer dispenser for operation based on all of the diverse variables associated with the installation and operation of a draft beer dispensing tap. Configuration may constitute automatic electronic entry of control functions and parameters, automatic adjustment and configuration of the volumetric flow controller, and motion configuration of the beverage nozzle to provide desired volumetric flow rate or rates, as well as a series of prompts with correct values or instructions for manual configuration. The electronic controller 44 can configure the dispenser based upon the brand or type of beer to be dispensed and the portion size, the type of volumetric flow control device and nozzle size being used, and the specific geometry of the beer flow pathway and associated flow components.

All of the pre-defined or operator determined functional parameters needed to dispense a particular beer at a particular dispense volume, at a particular speed, and with a particular foam finish, can be grouped by the operator as a “CMOS” or Complete Machine Operating Solution which can be stored into the non-volatile memory of the controller for use at any time. A large number of the CMOS setups can be stored, dependent upon the memory size specified for the controller.

In any draft beer tap installation, the size of the beer supply line, distance between the keg and the point of dispense, relative changes in elevation, and altitude of the installation, among many variables, can be defined and entered into the electronic controller 44. When this is done, the dispense parameters can be defined and optimized based upon these data. A major benefit of this data based setup is the ability of the present dispenser to optimize the priming or “line packing” function where hydraulic operation of the dispenser is established. Because system volume from the keg is known, and because volumetric flow rates through the beer flow pathway are defined by the dispenser, the minimum volume of beer required to prime the system, as installed, is known. Thus, the dispenser, placed in prime mode by the electronic controller, allows only enough beer to flow to achieve a ready to operate hydraulic status. Because beer flowing through the dispenser when packing the lines is generally wasted and discarded, the optional prime mode capability of the described systems is beneficial. In this regard, removing the amount of beer flow during priming from the discretion of the operator may also reduce draft beer waste.

In addition to the numerous alarm parameters and functions previously discussed, the electronic controller can monitor power supply voltages, battery supply conditions in portable applications, and it can track the operating cycles of the machine and store these totals such that proper maintenance intervals and life cycle replacements can be scheduled and conducted. A real time clock can also schedule and annunciate time based events, such as calendar based maintenance schedules.

The electronic controller, in combination with the volumetric flow rate control device, provides the capability to track and record beer usage for report and analysis purposes. In particular, because the volumetric flow rate of beer through the dispenser is known at all times, and because the controller can distinguish between serving pours and priming flow, the total beer available for serving pours is known after priming of any particular beer keg is completed. Thus, because the dispenser tracks and controls serving portion size, the number of beers servable and served from a keg are recorded. Further, because the volume of beer lost to priming is known, the beer depletion point of the keg can be computed. This may be annunciated when the keg is within a defined number of pours of “blow out”. The number of pours remaining at the warning can be user defined, generally among a list of choices ranging from two to ten pours. When a keg prime mode is again entered, the controller tracks the prime volume and dispense count on the next beer keg. The dispenser can set a “new keg” message that requests a confirmation that a new keg has been fitted, thus marking a new usage tracking and computation sequence.

The electronic controller also has the ability to accumulate and store inventory and point-of-sale data. It communicates bidirectionally to point-of-sale (POS) software systems and thus can be pre-pay enabled by such systems. It can also report each dispense including dispense size to the POS system. Thus, the beer dispenser herein disclosed becomes a sales activity and revenue data mode within the serving establishment.

The electronic controller enables bidirectional communication using all data transmission modes and media to PC's of all types, local area networks, server based systems, handheld and portable digital assistants (PDA's), as well as dedicated handheld devices.

Another aspect of particular implementations of the described beer dispenser is the ability to operate the beer dispensing nozzle using a mechanical manual override control in the event of an electronic controller or power failure. This feature provides a functional assurance of preserving beer-pouring capability even with a failure of the automated functions of the dispenser.

Two particular provisions are made to reduce the rate of bacterial growth on the exterior surface of the subsurface filling bottom shut-off beverage dispensing nozzle. First, the nozzle can be polished to a “mirror finish” high RA finish. This degree of smoothness promotes liquid (beer) runoff and reduces bacterial microgrowth sites. Second, the nozzle can be coated with one of several available antibacterial coatings which are suitable for food and beverage contact. Another aspect of dispenser cleaning is the role of the electronic controller. The controller can measure and define cleaning intervals based on operating cycles or elapsed time. It can also control and automate the cleaning function, including control of flow sequences, flow durations, and flow patterns. This capability is provided through the actuator based control of the beverage dispense nozzle which can directly control flow of cleaning liquids through the system. Also uniquely, the volumetric flow rate control device allows the volume of cleaning liquids used in a cleaning sequence to be defined, thus assuring cleaning effectiveness. The sequence(s) of actuations, durations, and volume of flow that constitutes a clean-in-place sequence can be stored in the electronic controller for use with each cleaning event.

The beer dispenser herein disclosed and detailed is easy to operate. It is well known and understood that the quality of retailing of draft beer varies greatly, and that there is often a rapid turnover of the serving personnel pouring draft beer, especially in stadium and festival settings. Thus, the ability of a server to place the subsurface filling bottom shut-off beverage dispensing nozzle at or near the bottom of the beer glass before the start of a pour and to simply keep it at the bottom to the end of the pour without any need to partially withdraw it or to move the glass such that the nozzle tracks with the increasing level of beer, comprises the simplest and least complicated draft beer pour technique known. This simplicity allows a demonstrable one beer pour training session before the server pours perfect beers.

Thus, beer dispensing systems can be sized and configurable to fit into approximately the same space as prior art devices, utilize an effective and simple flow rate limiting device to define and establish the volumetric rate of flow of carbonated beverage into the serving container, establish a volumetric flow rate of the carbonated beverage (typically beer) through the beverage flow pathway of the dispenser by a flow rate limiter at a flow rate which is generally accepted as optimum for dispensing into typical serving containers such as beer cups, glasses, steins, and pitchers, and minimize or eliminate the formation of bubbles in the beverage dispenser flow pathway or within its own structure as beverage flow occurs, in order to control and minimize foaming in the serving vessel.

Other implementations are within the scope of the following claims.

What is claimed is:

1. A method of dispensing a carbonated beverage from a beverage supply maintained at a pressure sufficient to cause flow to a beverage container, the method comprising the steps of:
providing a beverage dispensing system including
a volumetric flow rate controller comprising a substantially tubular flow restrictor and
a subsurface beverage dispensing nozzle assembly comprising a nozzle barrel having upper and lower ends and a positive bottom shut-off valve disposed proximate to the lower end of the nozzle barrel, said valve being movable between open and closed positions;
placing the beverage container about the lower end of the nozzle barrel such that the bottom of the beverage container is adjacent to the positive bottom shut-off valve;
initiating flow of the beverage into the container at a desired volumetric flow rate solely by opening the positive bottom shut-off valve; and
stopping flow of the beverage into the container solely by closing the shut-off valve.

2. The method of claim 1, further comprising the step of opening the positive bottom shut-off valve for a predetermined period of time to create a desired amount of foam in the beverage container.

3. The method of claim 2, wherein the predetermined period of time is a function of the volume of the beverage container and the flow rate of beverage from the nozzle assembly.

4. The method of claim 3, wherein the flow rate of beverage is substantially determined by beverage flow through the volumetric flow rate controller.

5. An apparatus for dispensing a carbonated beverage from a beverage source, comprising:
a volumetric flow rate controller comprising a substantially tubular restrictor in fluid communication with the beverage source;
a subsurface beverage dispensing nozzle assembly in fluid communication with the volumetric flow rate controller and including a nozzle barrel having upper and lower ends and a positive bottom shut-off valve disposed proximate to the lower end of the nozzle barrel, said valve being movable between open and closed positions; and
a controller for selectively moving the valve between open and closed positions,
wherein the beverage flows from the beverage source through a flow path defined by the volumetric flow rate controller and the subsurface beverage dispensing nozzle assembly.

6. The apparatus of claim 5, wherein the volumetric flow rate controller comprises a plurality of substantially tubular restrictors.

7. The apparatus of claim 6, wherein the plurality of substantially tubular restrictors are arranged to form a parallel beverage flow path through the volumetric flow rate controller.

8. The apparatus of claim 6, wherein the plurality of substantially tubular restrictors are arranged to form a serial beverage flow path through the volumetric flow rate controller.

9. The apparatus of claim 6, wherein the plurality of substantially tubular restrictors are arranged in combination to form both a parallel and a serial beverage flow path through the volumetric flow rate controller.

10. The apparatus of claim 5, wherein the tubular restrictor creates a serpentine flow path for the beverage through the volumetric flow rate controller.

11. The apparatus of claim 5, wherein the tubular restrictor creates a coiled flow path for the beverage through the volumetric flow rate controller.

12. The apparatus of claim 11, wherein the coiled flow path of the tubular restrictor is capable of being tightened to generate at least a partial compression of the restrictor.

13. The apparatus of claim 5, further comprising a pressure sensor disposed in the beverage flow path.

14. The apparatus of claim 5, further comprising a temperature sensor disposed in the beverage flow path.

15. The apparatus of claim 5, wherein the controller comprises a processor and a memory in data communication with the processor.

16. The apparatus of claim 5, wherein the controller adjusts flow through the volumetric flow rate controller in response to a change a beverage condition selected from the group consisting of: beverage temperature and beverage pressure.

17. A carbonated beverage dispensing system comprising:
a pressure source;
a beverage source in fluid communication with the pressure source, the beverage source holding a beverage pressurized to a desired level;
a volumetric flow rate controller comprising a tubular restrictor in fluid communication with the beverage source;
a subsurface dispensing assembly actuatable between a dispensing state and a non-dispensing state, said assembly in fluid communication with said volumetric flow rate controller; and
a means for actuating said beverage assembly from the dispensing state to the non-dispensing state.

18. The system of claim 17, wherein the means for actuating is in fluid communication with the pressure source.

19. The system of claim 17, wherein the volumetric flow rate controller is shaped to provide substantially hydraulic flow.

20. The system of claim 17, wherein the volumetric flow rate controller includes a cooling element.

21. The system of claim 17, further comprising a supply of cooling fluid disposed in close thermal contact with the volumetric flow rate controller.

22. The system of claim 17, wherein the means for actuating said beverage assembly comprises a piston.
